(19) United States
(12) Patent Application Publication
(10) Pub. No.: US 2009/0309437 A1
(43) Pub. Date: Dec. 17, 2009

(54) Motor

(76) Inventors: Alex Horng, Kaohsiung (TW); Chi Min Wang, Kaohsiung (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/173,909

(22) Filed: Jul. 16, 2008

(30) Foreign Application Priority Data
Jun. 11, 2008 (TW) 097121722

(51) Int. Cl. H02K 7/08; H02K 5/16

(52) U.S. Cl. 310/90

(57) ABSTRACT

A motor includes a housing, a rotor and a stator. The housing includes a shaft tube receiving a bearing. The rotor includes a shaft rotatably extending through the bearing and having an annular groove in a neck shape formed on an outer periphery thereof. The stator includes an assembling hole receiving the outer periphery of the shaft tube, with the stator including an upper bobbin, a lower bobbin, a plurality of silicon steel plates sandwiched between the upper and lower bobbins, and a winding wound around the plurality of silicon steel plates. The upper bobbin includes an abutting member formed on an inner periphery thereof. The abutting member abuts against the bearing and extends into the annular groove of the shaft to avoid the bearing and the rotor disengaging from the shaft tube. Consequently, assembling convenience and rotating stability of the motor are enhanced.

### BACKGROUND OF THE INVENTION

1. Field of the Invention

The present invention relatives to a motor and, more particularly, to a motor providing a stator to avoid a bearing and a rotor disengaging from a shaft tube.

2. Description of the Related Art

A conventional motor is shown in FIG. 1, which includes a housing 70, a rotor 80, and a stator 90. The housing 70 includes a hollow shaft tube 71 having a sealed bottom. A bearing 72, a retaining plate 73 and an oil end cap 74 are received in the shaft tube 71. The center of the rotor 80 includes a shaft 81 rotatably extending through the bearing 72. An annular groove 811 is formed on the shaft 81 and close to the free end of the shaft 81 for the inner edge of the retaining plate 73 extending into the annular groove 811. The stator 90 is mounted around the shaft tube 71 to drive the rotor 80 to rotate.

In general, for the conventional motor, the retaining plate 73 is partially received in the annular groove 811, so that the retaining plate 73 can prevent the rotor 80 and housing 70 from separation when the rotor 80 rotates, with said separation happening while the shaft 81 moves in a direction parallel to a longitudinal axis of the shaft tube 71. A part of the shaft 81 with a length “L” in longitudinal direction thereof for forming the annular groove 811 to receive the retaining plate 73 is defined, and the outer periphery of the shaft 81 in said part does not contact with the inner periphery of the bearing 72 when the rotor 80 rotates normally. However, because of the length “L” of the part, wherein the shaft 81 does not contact with the bearing 72, the contact area between the shaft 81 and the bearing 72 is reduced and this causes low rotating stability of the rotor 81. Especially, for a micro-motor, under the condition with limited contact area between the shaft 81 and the bearing 72, low rotating stability of the rotor 81 is induced more easily.

Furthermore, in order to prevent the rotor 80 and housing 70 of the conventional motor from separation, the retaining plate 73 must be partially received in the annular groove 811. Therefore, in assembly, the combinations between the shaft 81 of the rotor 80, the bearing 72, the retaining plate 73 and other related components are completed in the shaft tube 71, and thus it's difficult to check whether all the mentioned components are truly and stably coupled in the shaft tube 71 or not. Consequently, assembling quality of the conventional motor is uncontrollable and operation for assembling said motor is inconvenient.

### SUMMARY OF THE INVENTION

The primary objective of this invention is to provide a motor, which includes a stator having an abutting member to avoid a rotor and a bearing disengaging from a shaft tube. Accordingly, rotating stability and assembling convenience of the motor are enhanced.

The secondary objective of this invention is to provide the motor having the abutting member formed on an upper bobbin of the stator. Accordingly, structure of the motor is simplified.

The third objective of this invention is to provide the motor, which further includes a cover plate covering the bearing and abutted by the abutting member to avoid the rotor and the bearing disengaging from the shaft tube. Accordingly, positioning of the rotor and the bearing is improved.

The fourth objective of this invention is to provide the motor, which further includes the shaft tube having a positioning section on an outer periphery thereof for positioning the stator. Accordingly, the abutting member is positioned correctly and breakage thereof is avoided.

The motor in accordance with an aspect of the present invention includes a housing, a rotor and a stator. The housing includes a shaft tube receiving a bearing. The rotor includes a shaft rotatably extending through the bearing and having an annular groove in a neck shape formed on an outer periphery thereof. The stator includes an assembling hole receiving the outer periphery of the shaft tube, with the stator including an upper bobbin, a lower bobbin, a plurality of silicon steel plates sandwiched between the upper and lower bobbins, and a winding wound around the plurality of silicon steel plates. The upper bobbin includes an abutting member formed on an inner periphery thereof. The abutting member abuts against the bearing and extends into the annular groove of the shaft to avoid the bearing and the rotor disengaging from the shaft tube. Consequently, assembling convenience and rotating stability of the motor are enhanced.

Further scope of the applicability of the present invention will become apparent from the detailed description given hereinafter. However, it should be understood that the detailed description and specific examples, while indicating preferred embodiments of the invention, are given by way of illustration only, since various will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a cross sectional view illustrating a conventional motor;

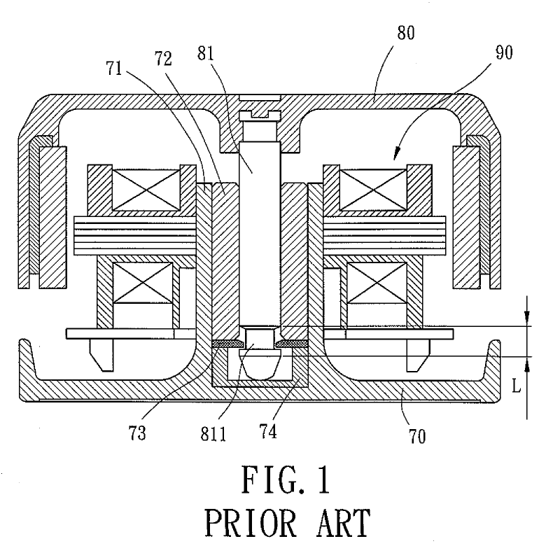

FIG. 2 is an exploded perspective view illustrating a motor in accordance with a first embodiment of the present invention;

FIG. 3 is a cross sectional view illustrating the motor in accordance with the first embodiment of the present invention;

FIG. 4 is a partial, perspective view of an upper bobbin of the motor of FIG. 3;

FIG. 5 is an exploded perspective view illustrating a motor in accordance with a second embodiment of the present invention;

FIG. 6 is a cross sectional view illustrating the motor in accordance with the second embodiment of the present invention;

FIG. 7 is a partial, perspective view of an upper bobbin of the motor of FIG. 6;

FIG. 8 is an exploded perspective view illustrating a motor in accordance with a third embodiment of the present invention;

FIG. 9 is a cross sectional view illustrating the motor in accordance with the third embodiment of the present invention; and

FIG. 10 is a partial, perspective view of an upper bobbin of the motor of FIG. 9.

In the various figures of the drawings, the same numerals designate the same or similar parts. Furthermore, when the terms “first”, “second”, “upper”, “lower” and similar terms are used hereinafter, it should be understood that these terms are reference only to the structure shown in the drawings as it would appear to a person viewing the drawings and are utilized only to facilitate describing the invention.

### DETAILED DESCRIPTION OF THE INVENTION

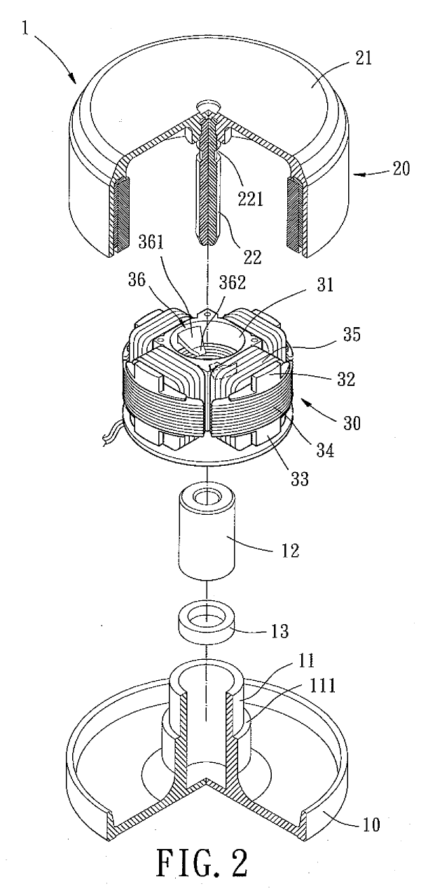

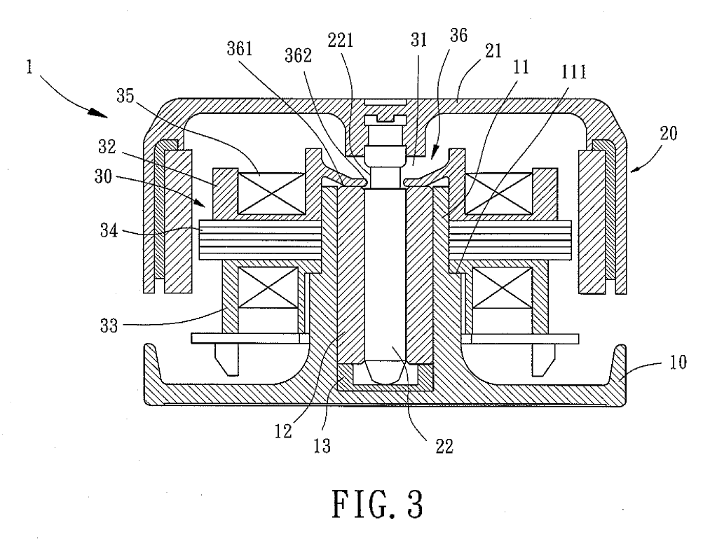

Referring initially to FIGS. 2 and 3, an exploded perspective view and a cross sectional view of a motor of a first embodiment according to the preferred teachings of the present invention is illustrated. The motor designated 1 includes a housing 10, a rotor 20 and a stator 30. The housing 10 includes a hollow shaft tube 11 having a sealed bottom. The shaft tube 11 receives a bearing 12, a supporting plate 13 and other components. Besides, the shaft tube 11 includes a positioning section 111 on an outer periphery thereof, with the positioning section 111 providing a supporting face opposite to the stator 30 when the housing 10 and the stator 30 are assembled. The supporting face is preferably perpendicular to the axis of the shaft tube 11.

The rotor 20 includes a hub 21 and a shaft 22. There may be a plurality of blades (not illustrated) disposed on an outer periphery of the hub 21, so that the rotor 20 can be taken as an impeller of a fan. One end of the shaft 22 is coupled to a center of the hub 21 and the other end thereof rotatably extends through the bearing 12 and abuts the supporting plate 13, so that the rotor 20 can rotate relatively to and is coupled to the housing 10 through the bearing 12. In addition, an annular groove 221 in a neck shape is formed on an outer periphery of the shaft 22 and away from the free end of the shaft 22 by which the shaft 22 abuts against the supporting plate 13. Therefore, the outer periphery of the shaft 22 close to the free end thereof can thus rotatably contact with the bearing 12 to enhance rotating stability of the rotor 20.

The stator 30 includes an assembling hole 31, so as to allow the stator 30 to be mounted around the shaft tube 11. Preferably, the stator 30 is coupled to the outer periphery of the shaft tube 11 by close-fit, bonding, or other suitable ways to reliably fix the stator 30 on the shaft tube 11. The stator 30 includes an upper bobbin 32, a lower bobbin 33, a plurality of silicon steel plates 34 sandwiched between the upper and lower bobbins 32 and 33, and a winding 35 wound around the silicon steel plates 34.

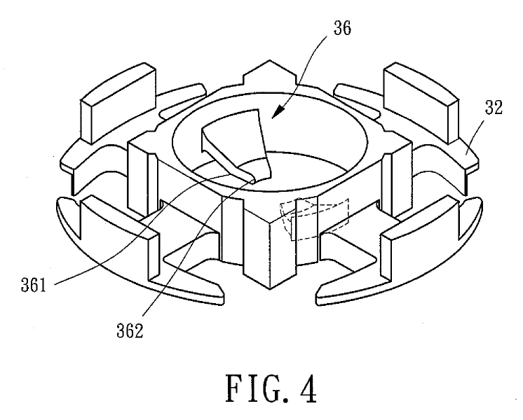

Referring now to FIG. 4, an abutting member 36 is formed on an inner periphery of the upper bobbin 32. The abutting member 36 abuts against the bearing 12 and extends into the annular groove 221 of the shaft 22, so as to avoid the bearing 12 disengaging from the shaft tube 11. Furthermore, because the abutting member 36 extends into the annular groove 221 of the shaft 22, the departure of rotor 20shaft tube 11 is avoided effectively by retaining the shaft 22 through the abutting member 36. In the first embodiment of the present invention, the abutting member 36 is in the form of a plurality of pressing plates, and said pressing plates are annularly formed on the inner periphery of the upper bobbin 32 with intervals. Moreover, each pressing plate has a first abutting portion 361 abutting against the bearing 12 to retain the bearing 12 and a second abutting portion 362 extending from the first abutting portion 361 into the annular groove 221 of the shaft 22 to prevent the rotor 20 from disengaging from the shaft tube 11.

The supporting face of the positioning section 111 of the shaft tube 11 provides the stator 30 with an axial supporting force along a longitudinal axis of the shaft tube 11, with the stator 30 being mounted around the shaft tube 11 and on the positioning section 111. Thus, the stator 30 is in an appropriate assembling position neither too high nor too low relative to the bearing 12, and the abutting member 36 can therefore abut against the bearing 12 appropriately and extend into the annular groove 221 of the shaft 22. It assures that loosening of the bearing 12 or the rotor 20 due to a higher assembling position of the stator 30 and breakage of the abutting member 36 due to a lower assembling position of the stator 30 are avoided. Therefore, the positioning section 111 of the shaft tube 11 positions the stator 30 to ensure the abutting member 36 works well and improve convenience of assembling the motor.

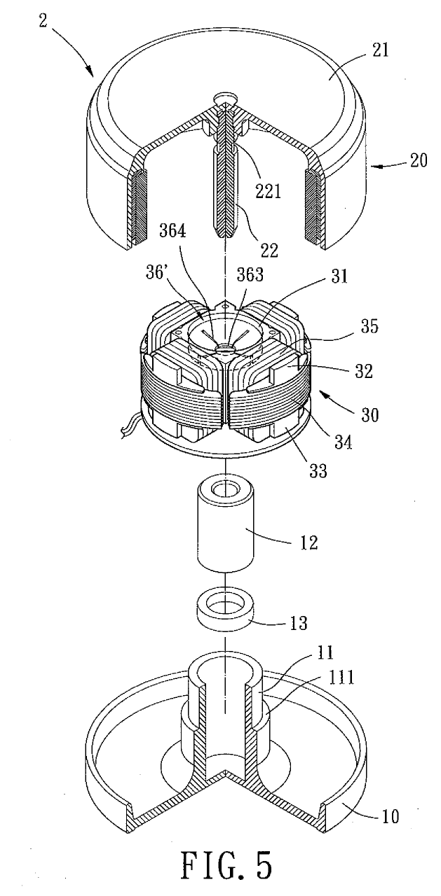

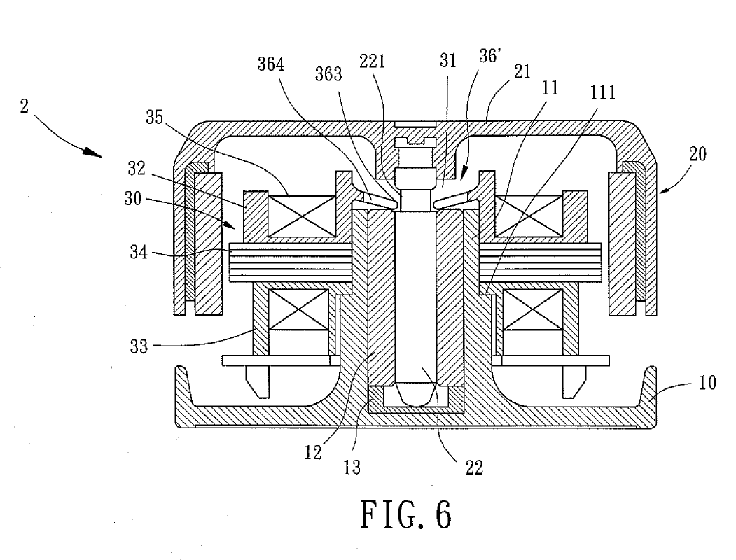

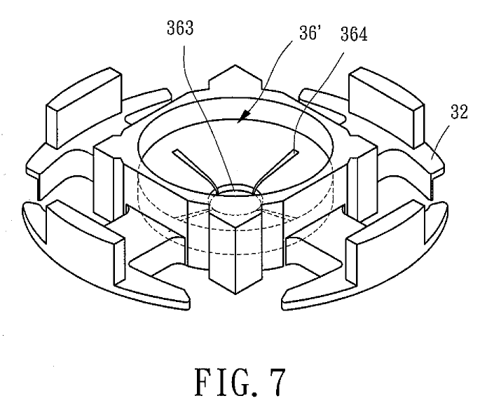

FIGS. 5, 6 and 7 show a motor 2 of a second embodiment according to the preferred teachings of the present invention modified from motor 1, wherein the abutting member 36′ of the stator 30 is in the form of an annular pressing ring formed on the inner periphery of the upper bobbin 32. The abutting member 36′ has a center hole 363 having a diameter smaller than an outer diameter of two sections of the shaft 22 and slightly larger than that of the neck of the shaft 22, with said two sections being adjacent to two end edges of the annular groove 221. The shaft 22 can thereby pass through the center hole 363 of the abutting member 36′, with the abutting member 36′ extending into the annular groove 221 of the shaft 22 to retain the shaft 22. Moreover, the abutting member 36′ preferably forms a plurality of gaps 364 extending radially and outwards from the inner edge of the abutting member 36′, so that the shaft 22 can easily pass through the center hole 363 of the abutting member 36′ in assembly. Therefore, the abutting member 36′ not only abuts the bearing 12 to prevent the bearing 12 from disengaging from the shaft tube 11 but also effectively avoid the rotor 20 disengaging from the shaft tube 11 by a positioning effect between an inner edge of the abutting member 36′ and the annular groove 221 of the shaft 22.

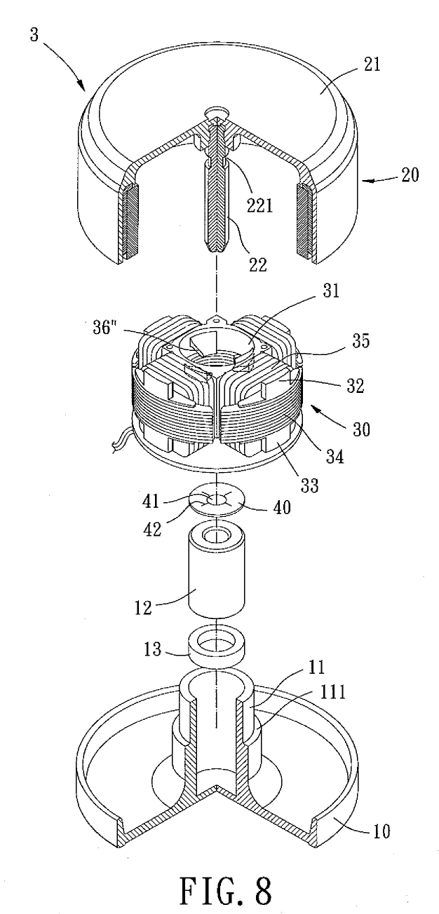

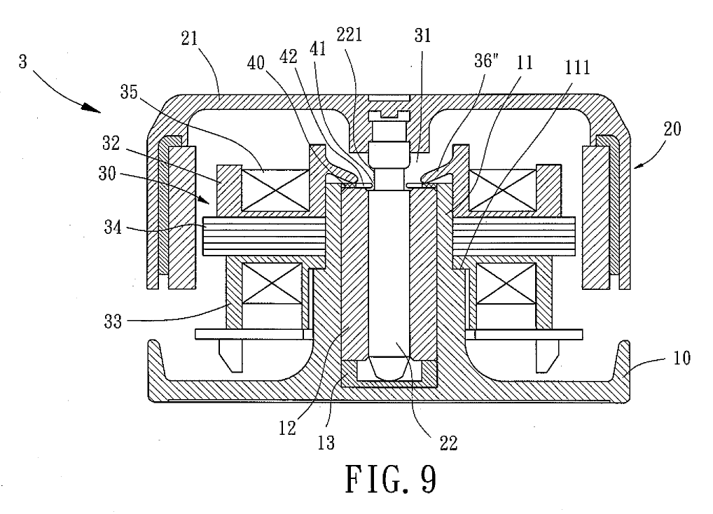

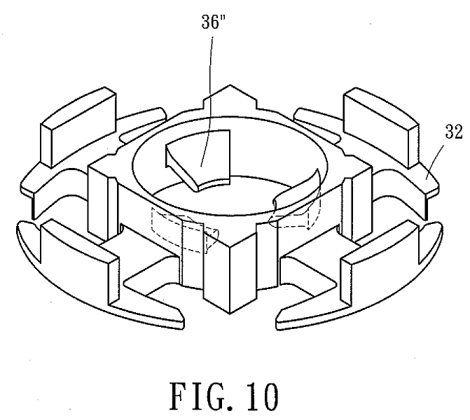

FIGS. 8, 9 and 10 show a motor 3 of a third embodiment according to the preferred teachings of the present invention modified from motor 1, wherein the motor 3 further includes a cover plate 40 with an axial hole 41 for mounting around the shaft 22. The cover plate 40 covers the bearing 12 and an inner edge thereof is in the annular groove 221 of the shaft 22. Besides, a plurality of gaps 42 is formed on the cover plate 40 and extends radially and outwards from the inner edge thereof, so that the shaft 22 can easily pass through the axial hole 41 of the cover plate 40 in assembly. The abutting member 36″ of the stator 30 is used to abut against the cover plate 40 to retain the bearing 12 and to prevent the rotor 20 disengaging from the shaft tube 11. In the third embodiment, the abutting member 36″ is in the form of a plurality of pressing blocks, and said pressing blocks are annularly formed on the inner periphery of the upper bobbin 32 with intervals. Moreover, a free end of each pressing block abuts against a top surface of the cover plate 40 to retain the bearing 12 and the shaft 12. Hence, a more reliable positioning effect for the bearing 12 and the rotor 20 is provided.

As has been discussed above, because preventing departure of the rotor 20 from the shaft tube 11 can be achieved by different kinds of the abutting members 36, 36′ and 36″, a part of the shaft 22 with a predetermined length near the bottom of the shaft 22 for receiving a retaining plate is not necessary. Therefore, the present invention without a need for the predetermined length can enhance the contact area between the bearing 12 and the shaft 22 to improve rotating stability of the rotor 20 effectively. Moreover, in assembling the motor of the present invention without a retaining plate, after the bearing 12 and other components being put into the shaft tube 11, the stator 30 being mounted around the shaft tube 11 and the shaft 22 of the rotor 20 being coupled with the bearing 12, the abutting members 36, 36′ and 36″ is used to avoid the rotor 20 disengaging from the bearing 12. Consequently, combination of the stator 30 and the shaft tube 11 or that of the stator 30, the bearing 12, the rotor 20 and other components can be checked outside the shaft tube 11, so that assembling quality and convenience of the motor of the present invention are easily controlled and improved respectively.

Besides, by using the abutting members 36, 36′ and 36″, not only the departure of the rotor 20 from the shaft tube 11 is prevented but also the holding of the bearing 12 is provided, so that prevention of departure of the bearing 12 and the rotor 20 from the shaft tube 11 is achieved at the same time. The positioning section 111 of the shaft tube 11 provides the stator 30 with the axial supporting force along the longitudinal axis of the shaft tube 11 to make the abutting members 36, 36′ and 36″ abut the bearing 12 appropriately, so that loosening of the bearing 12 and the rotor 20 due to higher assembling position of stator 30 and breakage of the abutting member 36 due to lower assembling position of stator 30 are avoided. Thus, assembling convenience is provided.

Although the invention has been described in detail with reference to its presently preferred embodiment, it will be understood by one of ordinary skill in the art that various modifications can be made without departing from the spirit and the scope of the invention, as set forth in the appended claims.

1. (canceled)

2. A motor comprising:
a housing including a shaft tube receiving a bearing;
a rotor including a shaft rotatably extending through the bearing and having an annular groove in a neck shape formed on an outer periphery thereof; and
a stator including an assembling hole receiving the outer periphery of the shaft tube, with the stator including an upper bobbin, lower bobbin, a plurality of silicon steel plates sandwiched between the upper and lower bobbins, and a winding wound around the plurality of silicon steel plates, wherein the upper bobbin includes an abutting member in the form of a plurality of pressing plates, wherein said pressing plates are annularly formed on an inner periphery of the upper bobbin with intervals, with the pressing plates extending from the inner periphery of the upper bobbin downward and inward toward a top surface of the bearing, with each pressing plate having a first abutting portion and a second abutting portion, with one end of the first abutting portion connecting to the inner periphery of the upper bobbin while another end of the first abutting portion abutting against the top surface of the bearing, with the first abutting portion being spaced from the shaft tube, with the second abutting portion extending from the first abutting portion into the annular groove of the shaft to avoid the bearing and the rotor disengaging from the shaft tube.

3. A motor comprising:
a housing including a shaft tube receiving a bearing;
a rotor including a shaft rotatably extending through the bearing and having an annular groove in a neck shape formed on an outer periphery thereof; and
a stator including an assembling hole receiving the outer periphery of the shaft tube, with the stator including an upper bobbin, a lower bobbin, a plurality of silicon steel plates sandwiched between the upper and lower bobbins, and a winding wound around the plurality of silicon steel plates, with the upper bobbin including an abutting member in the form of an annular pressing ring formed on an inner periphery of the upper bobbin and having a center hole receiving the shaft, with the annular pressing ring extending from the inner periphery of the upper bobbin downward and inward toward a top surface of the bearing, with the annular pressing ring being spaced from the shaft tube, with the annular pressing ring abutting against the bearing and extending into the annular groove of the shaft to avoid the bearing and the rotor disengaging from the shaft tube.

4. The motor as defined in claim 3, wherein a diameter of the center hole is smaller than an outer diameter of two sections of the shaft and slightly larger than that of the neck of the shaft, with said two sections being adjacent to two end edges of the annular groove.

5. The motor as defined in claim 4, wherein the annular pressing ring forms a plurality of gaps extending radially and outwards from an inner edge of the annular pressing ring.

6. The motor as defined in claim 3, wherein the shaft tube includes a positioning section on the outer periphery thereof, with the positioning section having a supporting face providing the stator with an axial supporting force along a longitudinal axis of the shaft tube.

7. A motor, comprising:
a housing including a shaft tube receiving a bearing;
a rotor including a shaft rotatably extending through the bearing and having an annular groove on an outer periphery thereof;
a cover plate including an axial hole receiving the shaft, with an inner edge of the cover plate extending into the annular groove of the shaft; and
a stator including an assembling hole receiving the outer periphery of the shaft tube, with the stator including an upper bobbin, a lower bobbin, a plurality of silicon steel plates sandwiched between the upper and lower bobbins, and a winding wound around the plurality of silicon steel plates, with the upper bobbin including an abutting member formed on an inner periphery thereof with the abutting member extending from the inner periphery of the upper bobbin downward and inward toward a top surface of the bearing, with the abutting member being spaced from the shaft tube, with the abutting member abutting against the cover plate to avoid the bearing and the rotor disengaging from the shaft tube.

8. The motor as defined in claim 7, wherein the abutting member is in the form of a plurality of pressing blocks, and the pressing blocks are annularly formed on the inner periphery of the upper bobbin with intervals, with a free end of each pressing block abutting against a top surface of the cover plate.

9. The motor as defined in claim 7, wherein the cover plate forms a plurality of gaps extending radially and outwards from the inner edge of the cover plate.

10. The motor as defined in claim 7, wherein the shaft tube includes a positioning section on the outer periphery thereof, with the positioning section having a supporting face providing the stator with an axial supporting force along a longitudinal axis of the shaft tube.

11. The motor as defined in claim 2, wherein the shaft tube includes a positioning section on the outer periphery thereof, with the positioning section having a supporting face providing the stator with an axial supporting force along a longitudinal axis of the shaft tube.
